(19) United States
(12) Patent Application Publication
(10) Pub. No.: US 2003/0088019 A1
(43) Pub. Date: May 8, 2003

(54) Material made from a polyurethane gel, production process and uses

(76) Inventors: Barbara Pause, Longmont, CO (US); Adolf Stender, Duderstadt (DE); Peter Gansen, Seeburg (DE)

Correspondence Address: HUSCH & EPPENBERGER, LLC, 401 Main Street, Suite 1400, Peoria, IL, 61602, US

(21) Appl. No.: 10/199,795

(22) Filed: Jul. 19, 2002

Related U.S. Application Data
(60) Provisional application No. 60/306,644, filed on Jul. 19, 2001.

(30) Foreign Application Priority Data
May 6, 2002 (EP) 02010042.6

(51) Int. Cl. C08K 3/00; C08K 5/01

(52) U.S. Cl. 524/589; 524/487

(57) ABSTRACT

Polyurethane gel materials comprising finely divided Phase Change Materials (PCMs)—for example crystalline saturated hydrocarbons—facilitate heat regulation due to heat absorption and heat release in the phase transition range of the PCM, which improves comfort when using the gel material in items such as shoe soles, bicycle seats, chair cushions and the like.

### CROSS REFERENCE TO RELATED APPLICATIONS

This application claims priority of pending U.S. Application No. 60/306,644, filed Jul. 19, 2001 entitled “Polyurethane Gel Materials Comprising Phase Change Material,” and European Patent Application 02010042.6 filed on May 6, 2002.

### TECHNICAL FIELD OF THE INVENTION

The invention relates generally to a polyurethane gel material and, more particularly, to a material comprised of a polyurethane gel having finely divided phase transition materials—so-called “Phase Change Materials” (PCM)—and a process for producing such materials.

### DESCRIPTION OF THE RELATED ART

The introduction of materials, which absorb and store large quantities of heat from the surroundings during a phase change from the solid to the liquid physical state, into those which do not undergo a change in physical state within the same temperature range, leads to a climatizing effect. This climatizing effect is required for functional textiles (in the field of sport and leisure).

The phase transition materials introduced or applied, so-called PCM, have the ability to change their physical state within a certain (required and adjustable) temperature range. On reaching the melting temperature during a heating process, phase transition from the solid into the liquid state commences. During this melting process, the PCM absorbs and stores considerable latent heat. The temperature of the PCM remains virtually constant during the entire process.

During the subsequent cooling process leading to the formation of a crystalline or, more seldom, an amorphous state, the stored heat is released again from the PCM to the surroundings., the stored heat is released again from the PCM to the surroundings. Like in other phase transition processes, the temperature of the PCM during this transition from the liquid to the solid state remains constant.

Before its introduction into functional textiles, the PCM is microencapsulated to prevent leakage of the molten PCM into the textile structure.

For better understanding, the amount of latent heat which is absorbed by a PCM during phase transition is compared with the specific heat in a conventional heating process. For comparison, the ice-water transition is used. When ice melts, it absorbs a latent heat of about 335 J/g. When the water is heated further, it absorbs a specific heat of only 4 J/g, during a temperature increase of 1° C. The absorption of latent heat during the phase transition from ice to water is therefore almost 100 times greater than the absorption of specific heat during the normal heating process outside the phase transition range.

Apart from the system ice/water, more than 500 natural and synthetic PCMs are known. These materials differ in their phase transition temperatures and their heat-absorption capacities.

Currently, only crystalline hydrocarbon PCMs having different chain lengths are used for finishing yams and textiles. The characteristics of these PCMs are summarized in the following Table 1:

| Phase Change | Melting | Crystallization | Heat storage |
|---|---|---|---|
| Material | temperature [° C.] | temperature [° C.] | capacity [J/g] |
| Heneicosane | 40.5 | 35.9 | 213 |
| Eicosane | 36.1 | 30.6 | 247 |
| Nonadecane | 32.1 | 26.4 | 222 |
| Octadecane | 28.2 | 25.4 | 244 |

The crystalline alkanes used are generally about 95% pure, or are used in mixtures which should cover certain phase transition temperature ranges. The crystalline alkanes are non-toxic, non-corrosive and non-hygroscopic. The thermal behavior of these PCMs also remains stable even for continuous use. Crystalline alkanes are side products from oil refineries and therefore are relatively cheap. Furthermore, they can be obtained in a pure state and also in mixtures defined by melting range.

Only microencapsulated crystalline alkanes, enclosed in small microcapsules having diameters of about 1 to 30 microns, are currently used as PCMs in the textile industry. These microencapsulated PCMs are applied to fabric by introducing them into acrylic fibers or polyurethane foams and applying them as a coating to the fabric.

U.S. Pat. No. 4,756,958 describes a fiber having integrated microcapsules which are filled with PCM. The fiber has improved thermal properties within a predetermined temperature range.

U.S. Pat. No. 5,366,801 describes a coating made from PCM-filled microcapsules used for the purpose of furnishing textiles with improved thermal properties.

U.S. Pat. No. 5,637,3 89 describes an insulating foam with improved thermal behavior, wherein the PCM microcapsules are embedded in the foam.

Microencapsulating processes are very time-consuming and complicated multi-stage processes. Microencapsulated PCMs are therefore very expensive.

Apart from use in thin coatings, the addition of microencapsulated PCMs is not conventional for plastics (polymers), e.g., molded bodies, since the heat transfer in the interior would be very poor.

Polyurethane gels are known for high deformability, but they always return to a given shape. They are used in seat cushions and upholstery. However, upon body contact, these polyurethane gels contact often lead to an unpleasant cold feeling and generally poor climatizing.

### SUMMARY OF THE INVENTION

An object of the invention is to improve the thermal behavior of polyurethane gels in the sense of temperature-compensating behavior.

To achieve this object, the invention provides a material made from a polyurethane gel, which contains finely divided PCMs.

### BRIEF DESCRIPTION OF THE DRAWINGS

FIG. 1 shows a temperature development in the shoe microclimate.

FIG. 2 shows moisture development over 30 minutes.

### DETAILED DESCRIPTION

It has been found, surprisingly, that the PCMs do not have to be encapsulated and nevertheless do not diffuse out or agglomerate. Finely divided PCMs emulsified or dispersed in the polyurethane gel remain stable over long service times.

The polyurethanes used for polyurethane gels are covalently crosslinked polyurethane matrices having high molecular weights. The gel structure comes about by suitable selection of the functionalities and molecular weights of the starting components. The polyurethane gels used may contain additional materials and additives which are conventional in polyurethane chemistry.

The gel compositions used for the invention are preferably produced using raw materials of a combined isocyanate polyol functionality of at least 5.2, preferably at least 6.5, and more preferably at least 7.5. The functionality of the polyol component may be at least 2.5, preferably 3 or higher.

The polyol component for producing the gel may consist of one or more polyols having a molecular weight between 1,000 and 12,000 and an OH number between 20 and 112. Polyols of higher OH numbers may be included to modify the ratio of polyol to isocyanate.

Isocyanates for gel production of the formula Q(NCO)n are preferably used, wherein n represents 2 to 4 and Q is an aliphatic hydrocarbon residue having 8 to 18 C atoms, a cycloaliphatic hydrocarbon residue having 4 to 15 C atoms, an aromatic hydrocarbon residue having 6 to 15° C. atoms or an araliphatic hydrocarbon residue having 8 to 15 C atoms. The isocyanates may thus be used in pure form or in a conventional isocyanate modification that is generally known to experts, such as urethanisation, allophanatisation or biuretisation, for example.

Typical isocyanates used are members of TDI and HDI families for aromatic gels and of HDI and IPDI families for aliphatic gels. The NCO content may lie between 7% and 60%, preferably between 10% and 20%.

In principle all PCMs may be used as phase transition materials or PCMs, the phase transition of which lies in the required temperature range, and can be bound during gel production. These may be, for example paraffins or fats. Crystalline alkanes are preferably used.

The melting points or melting ranges of the PCMs used preferably lie between 20 and 45° C., or more preferably between 34 and 39° C. For applications, in which the material close to the body should ensure compensation of the body temperature, a phase transition range for average human body temperature is ideal to immediately control overheating—for example during sports.

The PCMs are preferably incorporated in a weight portion of up to 60 wt. %, but also preferably up to 40 wt. %, based on the total weight in the material.

In addition, fillers may be present in the material. One skilled in the art may select the fillers and the quantities of these fillers which can be used within the framework of what is generally known in polymer chemistry and in particular in polyurethane chemistry. Resilient microspheres may also be provided as fillers and the shells preferably consist of polymer material, such as polyolefin. The resilient microspheres may, if necessary, be expanded or expandable under processing conditions. Microspheres are gas-filled (air-filled) microballoons, wherein the spherical shape is immaterial. “Microcellular material” or microcells are also often mentioned. The microspheres reduce the specific weight and have an effect on the mechanical properties of the material. Up to 20, but preferably up to 10, wt. % of microcells are used. Suitable microspheres, as well as other fillers, are commercially available.

The material may be used, inter alia, for the production of shoe insoles, shoe linings, mattresses, seat supports and entire seat cushions. Further additives or fillers may thus be incorporated into the material, as is known in the state of the art. Shoe insoles may preferably consist of the novel material, in some particular regions, such as the region of the foot pressure points.

Soles, mattresses, seat supports and cushions may be provided with a textile covering. The material of the invention may be laminated directly onto textile materials.

The invention also includes a process for producing the novel material. It is preferable to use the polyurethane components already mentioned above. Suitable compositions for polyurethane gels are described in European 057 838 and also European 0 511 570. The PCMs are added to the starting components or, at the latest, during gel formation. They are thus permanently embedded in the solid polyurethane structure being formed.

The material of the invention may advantageously be produced by emulsifying or by dispersing the PCM in a liquid polyurethane (PU) component and then converting the PU components to the polyurethane gel. Alternatively, the PCM may also be introduced into the final polyurethane mixture before gel formation. Which procedure is selected depends on the required distribution profile. One skilled in the art may determine the particular best possibility for incorporating the PCM using tests.

In a particularly preferred embodiment, the PCM, preferably an alkane, is used in liquid physical state (molten). The liquid PCM is initially incorporated into the polyol component, forming a liquid/liquid emulsion, which is then further processed in the conventional manner that is known in the art. The degree of fine distribution of the PCM in the emulsion depends on the intensity and duration with which it is mixed or stirred. In addition, suitable additives, such as stabilizers and emulsifiers, influence the degree of fine distribution. One skilled in the art may adjust this within certain limits and thus influence the distribution of the PCM in the later material.

The emulsion may preferably be stabilized by the addition of an emulsion stabilizer.

In an alternative preferred embodiment, the liquid PCM may be mixed with all components of the later gel material and intensively stirred until gel formation starts. As the gel begins to form the composition is then generally poured into the moulds predetermined by the required products.

In other preferred embodiments, solid, pulverulent PCMs could be incorporated into the gel or dispersed in the polyol component. The processing is otherwise conducted in a conventional manner.

The use of microencapsulated PCMs would also be possible within the gel material of the invention, but only in an impaired embodiment. This is so because the encapsulation fundamentally prevents the heat transfer, reduces the heat capacity and makes the product more expensive.

Polyurethane gels have numerous advantageous properties, which are already utilized in the state of the art for many products. These known properties, such as good pressure distribution capacity, high shock and shearing-force absorption, high elasticity and good recovery ability, are also retained in the novel material comprising PCMs. In the novel material, good climatizing behavior, that is good heat-regulating behavior, is an advantageous characteristic added to the properties of known polyurethane gels. The thermal conductivity of the PU gels of about 0.410 W/mK, which is high for polymers, permits very good heat transport between PCMs and their surroundings.

The novel material is particularly useful where excess heat, for example from the body of a person, is to be buffered. Excess heat is temporarily absorbed by the material, due to the high heat capacity of the PCM during phase transition, and is released again during body cooling, if necessary. For example, excess heat produced by the foot during running, may be absorbed by an insole made from the novel material.

The structure of the polyurethane gel material permits high loading with PCMs, for crystalline alkanes up to about 60 wt. %, based on the total weight of the material, but preferably up to 40 wt. %. In addition, the polyurethane gel may contain further additives which are already known for polyurethane gels, such as particles of low density.

For example, in a polyurethane gel material having a thickness of 1.5 mm and a weight of 1,760 g/m², a heat absorption capacity of about 140 kJ/m² may be achieved, when crystalline alkanes having a latent heat capacity of about 200 J/g are used. The heat storage capacity may be increased up to about 250 kJ/m², when the alkane PCM is used in a gel material having a specific weight of 3,150 g/m². The heat absorption capacity, which may be achieved in this manner, by far exceeds the capacity of current PU foams having microencapsulated PCMs, which lies at 20 to 40 kJ/m². Textiles coated with microencapsulated PCMs have latent heat absorption capacities of between 5 kJ/m² and 15 kJ/m².

The invention is illustrated below, using insoles as an example.

### EXAMPLES

I. Insoles made from PCM-Containing Polyurethane Gel

The excess heat released from the foot should be absorbed by the PCM and hence the temperature rise on the skin should be noticeably delayed. The delay of the temperature rise leads to the delay and minimization of sweat formation which is later starting and also less, which results in a considerable improvement in thermophysiological comfort. A significant improvement in wearer comfort when using the insoles in the widest variety of shoe variants is achieved from the combination of excellent mechanical properties of the polyurethane gel materials and the thermal effect of the PCMs.

1. Determination of the Thermophysical Characteristics

The investigations were carried out on the following insoles:

A. PCM-containing PU gel sole with 20% paraffin PCM

B. PCM-containing PU gel sole with 40% paraffin PCM

C. PCM-containing PU gel sole with 10% microencapsulated paraffin PCM (THS 95)

D. PCM-containing PU gel sole with 20% microencapsulated paraffin PCM (THS 95)

E. PU gel insole without PCM

F. PU gel insole with 25% paraffin PCM (CeraSer 318)

G. PU gel insole with 25% paraffin PCM (CeraSer 318) and 2% microspheres.

The percentage details relate in each case to wt. % based on the total weight of the material.

Commercially available pure paraffins and paraffin mixtures, which are characterized by their melting range or melting point, were used as paraffin PCM, (one example of a commercially available paraffin mixture is Cera Ser®).

A calorimetric DSC measuring device aids the determination of the temperature ranges of latent heat absorption and release of the paraffin PCM present in the insoles were determined with the aid of a calorimetric DSC measuring device. Heat storage capacity is also established.

The results of the DSC tests are summarized in Table 1. The temperature ranges of the latent heat absorption and the latent heat release, the melting and crystallization temperatures (peak values) and the latent heat absorptions and releases were determined in these measurements for the paraffin PCMs present in the PU gel insoles. All results are average values from in each case three tests.

TABLE 1
Measured results of the DSC tests

| | Temper- | Melting | Latent | | Crystal- | |
|---|---|---|---|---|---|---|
| | ature | temper- | heat | Temperature | lization | Latent |
| Test | range heat | ature | absorp- | range heat | tempera- | heat |
| mate- | absorption | (peak) | tion | release | ture (peak) | release |
| rial | in ° C. | in ° C. | In J/g | in ° C. | in ° C. | in J/g |
| A | 18-38 | 32.86 | 9.78 | 10-35 | 28.46 | 11.29 |
| B | 18-45 | 35.40 | 20.98 | 15-38 | 34.23 | 21.54 |
| C | 25-38 | 35.04 | 9.44 | 13-23 | 18.38 | 1.55 |
| | | | | 23-35 | 32.11 | 5.45 |
| D | 25-38 | 35.03 | 12.25 | 13-23 | 17.97 | 2.11 |
| | | | | 23-35 | 32.26 | 6.49 |

The effect of fillers was also investigated. The results of DSC tests for one insole with and one insole without microcells or microspheres in the gel, and a sole without PCMs, are summarized in Table 2. All results are average values from in each case three measurements.

TABLE 2
DSC on PCM-PU gel insoles with and without microspheres

| | Temper- | Melting | Latent | Temper- | Crystal- | |
|---|---|---|---|---|---|---|
| | ature | temper- | heat | ature | lization | Latent |
| Test | range heat | ature | absorp- | range heat | tempera- | heat |
| mate- | absorption | (peak) | tion | release | ture (peak) | release |
| rial | in ° C. | in ° C. | in J/g | in ° C. | In ° C. | in J/g |
| PU gel | 15-20 | 18.01 | 0.39 | 10-17 | 15.42 | 0.53 |
| 25% | 20-40 | 35.27 | 19.56 | 17-36 | 31.29 | 21.78 |
| Cera | | | | | | |
| Ser 318 | | | | | | |
| without | | | | | | |
| MB | | | | | | |
| PU gel | 15-20 | 18.21 | 0.38 | 10-17 | 14.85 | 0.37 |
| 25% | 25-43 | 35.56 | 17.40 | 17-37 | 32.36 | 18.11 |
| Cera | | | | | | |
| Ser 318 | | | | | | |
| with | | | | | | |
| MB | | | | | | |

MB = Microcells/microspheres

The measured results from Table 2 show that the latent heat capacity of the insoles is reduced by about 15%, with the addition of about 2% of air-filled microcells (MB). The temperature ranges of the latent heat absorption or heat release are displaced somewhat to higher temperatures by the addition of air-filled microcells.

The PU gel insoles used have different sizes and have, consequently, different weight. Table 3 contains the weights of the insoles used in the investigations. With reference to the sole weight, the latent heat storage capacity of the insoles was determined. The value indicated in brackets relates to a uniform insole size, which corresponds to the shoe size 39/40. The shoe size was used in the wear tests.

TABLE 3
Weights of the insoles and latent heat storage capacity of the
paraffin PCMs present in the soles

| | | Latent heat storage |
|---|---|---|
| | Weight | capacity |
| Insole | in g | in kJ |
| A | 68 | 0.7 |
| B | 69 | 1.5 |
| C | 84 | 0.6 (0.4) |
| D | 84 | 0.8 (0.7) |
| E | 50 | — |

2. Property Tests—Wear Tests

The properties of the various soles were investigated by wear tests using test people.

The tests consisted of a 30-minute run in a climatic chamber, on the running belt ergometer at a speed of about 8 km/h. During the tests, the ambient temperature was 21° C. and the relative air humidity 40%. For the tests, the particular sole model was inserted in a normal sports shoe. In the tests, the test persons wore cotton socks and normal sports clothing.

During the tests, the temperature course was determined continuously using a logger system, at a total of 4 skin measuring points (big toe, back of the foot, top bone and base of the foot) and at two points on the surface of the insole. The average skin temperature was calculated from the temperature measured values at the four different skin measuring points. The measured results of the two sensors, which were located on the surface of the insole, were likewise determined. In addition, the moisture increase was determined in the microclimate. Each sole model was tested twice and the test results obtained were averaged.

The following were investigated:

1. Polyurethane gel insole without PCM;

2. Polyurethane gel insole with 25% microencapsulated PCM;

3. Polyurethane gel insole with 25% pure PCM; and

4. Polyurethane foam insole with 50% microencapsulated PCM (% details in each case in wt. %).

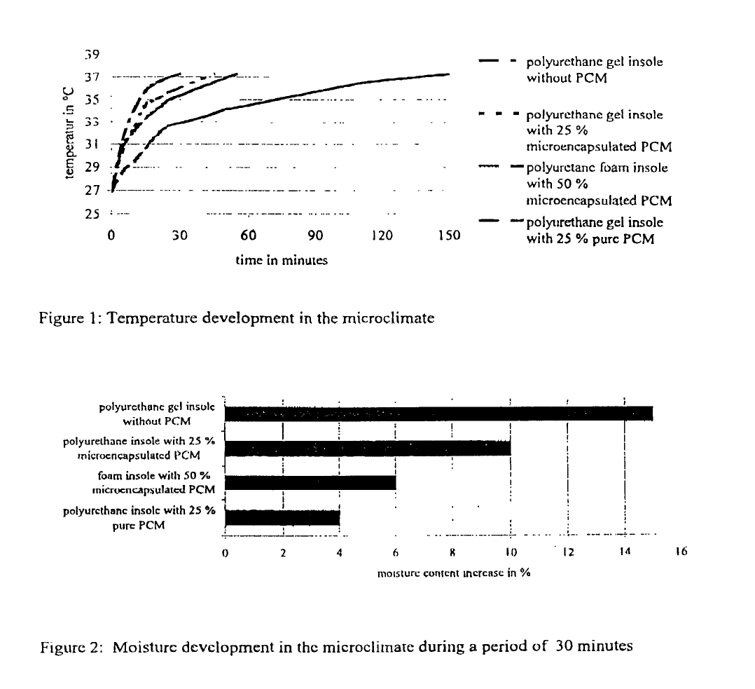

Reference is now made to the drawings which shows the results of the investigations. In the 30-minute running test, the temperatures shown in FIG. 1 were measured on the surface of the PU gel insoles. The test results show that when using a polyurethane gel insole without PCM, even after 30 minutes, a final temperature of about 37° C. is achieved in the running shoe microclimate. By adding 25% of microencapsulated PCMs to this polyurethane gel insole, this time span is extended by approximately 15 minutes. However, the use of 25% pure, non-encapsulated PCM extends the time span to reaching the final temperature to a total of 150 minutes. By using non-encapsulated PCMs in the polyurethane gel insole, a considerable and long-lasting cooling effect is therefore achieved. The reason for the only shorter cooling effect of the corresponding sole with microencapsulated PCM can be seen due to losses of the latent heat capacity through the microencapsulation itself and a greater heat transfer resistance to the microcapsules. In spite of the considerably higher PCM portion, a significantly lower cooling effect is achieved for the PU foam sole with microencapsulated PCM, due to the strongly impeded and delayed heat transfer in the foam and through the microcapsules.

The delay of the temperature rise in the shoe microclimate during running is also evidenced by a delayed moisture rise. The test results for the moisture increase in the microclimate of the shoe during running over a period of time of 30 minutes are summarized in FIG. 2. The heat absorption due to the PCM leads to a considerably lower moisture rise in the microclimate of the shoe. This leads overall to a significant increase in comfort when wearing the insoles embodying the invention. Material made from PCM-containing polyurethane gel may also improve the climatic behavior of bicycle seats, chair cushions, car seats, wheel-chair seats or mattresses, to mention but a few examples.

Other objects, features and advantages will be apparent to those skilled in the art. While preferred embodiments of the present invention have been illustrated and described, this has been by way of illustration and the invention should not be limited except as required by the scope of the appended claims.

What is claimed is:

1. A material comprising a polyurethane gel having finely divided Phase Change Materials present therein.

2. A material according to claim 1, wherein the polyurethane gel is produced using raw materials of an isocyanate functionality and a polyol functionality of at least 5.2.

3. A material according to claim 1, wherein the polyurethane gel is produced using raw materials of an isocyanate functionality and a polyol of at least 6.5.

4. A material according to claim 1, wherein the polyurethane gel is produced using raw materials of an isocyanate functionality and a polyol functionality of at least 7.5.

5. A material according to claim 1, wherein the Phase Change Materials are paraffins.

6. A material according to claim 1, wherein the Phase Change Materials are fats.

7. A material according of claim 1, wherein the Phase Change Materials have melting points in the range between 20 and 45° C.

8. A material according of claim 1, wherein Phase Change Materials have melting points in the range between 34 and 39° C.

9. A material according to claim 1, wherein the Phase Change Materials are present in a weight portion of up to 60 wt. %, based on the total weight in the material.

10. A material according to claim 1, wherein the Phase Change Materials are present in a weight portion of up to 40 wt. %, based on the total weight in the material.

11. A material according to claims 1, wherein said material further includes fillers.

12. A material according to claim 11, wherein said fillers are resilient microspheres.

13. A material according to claim 12, wherein said resilient microspheres are made from a polymer material.

14. A material according of claim 1, wherein Phase Change Materials is embedded directly in a matrix of the polyurethane gel without an encapsulation.

15. A process for producing a polyurethane gel having finely divided phase transition materials, including the steps of:
emulsifying a Phase Change Material in a liquid polyurethane component and
converting the polyurethane component to polyurethane gel.

16. A process according to claim 15, wherein the step of emulsifying the Phase Change Material includes emulsifying the Phase Change Material in a plurality of liquid polyurethane components.

17. A process according to claim 15, wherein the polyurethane component for producing the gel consists of one or more polyols having a molecular weight between 1,000 and 12,000 and an OH number between 20 and 112; and the product of the functionalities of the polyurethane-forming components is at least 5.2.

18. A process according to claim 15, including the step of using isocyanates of the formula Q(NCO)n for gel production, wherein
n represents 2 to 4 and
Q is selected from the group consisting of an aliphatic hydrocarbon residue having 8 to 18 C atoms, represents a cycloaliphatic hydrocarbon residue having 4 to 15 C atoms, represents an aromatic hydrocarbon residue having 6 to 15 C atoms, and represents an araliphatic hydrocarbon residue having 8 to 15 C atoms.

19. A process according to claim 18, wherein the isocyanates have a NCO content of 7% to 60%.

20. A process according to claim 18, wherein the isocyanates have a NCO content of 10% to 20%

21. A process according to claim 18, wherein the isocyanates are used in pure form.

22. A process according to claim 18, wherein the isocyanates are used in modified form.

23. A process according to claim 18, wherein the isocyanates are selected from the group consisting of urethanised, allophanatised, and biuretised isocyanates.

24. A process according to claim 15, wherein the Phase Change Material is used in liquid physical state.

25. A process according to claim 22, including the step of incorporating the Phase Change Material into the polyol component with formation of a liquid/liquid emulsion.

26. A process according to claim 23, including the step of adding an emulsion stabilizer.

27. A process according to claim 15, including the step of encapsulating the Phase Change Material.

28. A process according to claim 15, including the step of embedding the Phase Change Material directly into a matrix of polyurethane gel without encapsulating.

29. A use of a material comprising a polyurethane gel having finely divided Phase Change Materials present therein for the production of human body proximity products, such as shoe insoles, shoe linings, mattresses, bicycle seats, and chair cushions.

30. A shoe insole having in at least some regions a material comprising a polyurethane gel having finely divided Phase Change Materials present therein, and a textile covering.
